(19) United States
(12) Patent Application Publication
(10) Pub. No.: US 2009/0003956 A1
(43) Pub. Date: Jan. 1, 2009

(54) FURTHER IMPROVED VEHICLE TIRE TIE-DOWN SYSTEM AND METHOD

(76) Inventor: Richard A. Tatina, Countryside, IL (US)

Correspondence Address: SCHIFF HARDIN, LLP;PATENT DEPARTMENT, 6600 SEARS TOWER, CHICAGO, IL, 60606-6473, US

(21) Appl. No.: 11/769,868

(22) Filed: Jun. 28, 2007

(51) Int. Cl. B60P 3/075

(52) U.S. Cl. 410/20

(57) ABSTRACT

In a vehicle wheel tie-down system for tying a wheel of a vehicle at a load carrying platform having an associated engagement receiving member by use of a strap, a wheel chock and winch assembly has a winch for receiving an end of the strap and a springable chock arm for resting against a surface of the wheel when the wheel chock and winch assembly is positioned at the wheel.

### RELATED APPLICATION

The present application is related to application U.S. Ser. No. 11/623,768 filed Jan. 17, 2007 titled: “Improved Vehicle Tire Tie-Down System and Method”, inventor Richard A. Tatina.

### BACKGROUND

The present application relates to a vehicle tire tie-down system and method. In U.S. Pat. No. 6,530,729, a vehicle tire tie-down system is disclosed employing first and second winch and chock assemblies which lock to a load carrying platform such as on a railcar or other load carrying vehicle which supports a vehicle to be transported. Tires (also called wheels herein) of the vehicle being transported are secured to the platform by use of the first and second winch and chock assemblies together with a tire harness. Ends of the tire harness are secured to the first and second winch and chock assemblies. A winch of at least one of the two winch and chock assemblies is tightened to tighten a tire harness. An anchor channel is provided at a top surface of the platform. The anchor channel has upper inwardly extending flanges and notches at spaced locations. Each of the winch and chock assemblies has respective downwardly extending bar-shaped lugs at a front and back end received within the notches. A lock mechanism is provided having a rectangular rotatable lock element. When a lock handle is pushed, the winch and chock assembly is placed onto the channel with a longitudinal extent of the lock element aligned with the longitudinal extent of the channel. Thereafter the lock handle is pushed back and ends of the lock element then lie beneath the flanges to prevent upward movement of the assembly. The lugs prevent lateral and longitudinal movement.

### SUMMARY

It is an object to improve upon the system and method of U.S. Pat. No. 6,530,729 described above.

A vehicle wheel tie-down system is provided for tying a wheel of a vehicle at a load carrying platform having an associated engagement receiving member by use of a strap. A wheel chock and winch assembly is provided having a winch for receiving an end of the strap and a springable chock arm for resting against a surface of the wheel when the wheel chock and winch assembly is positioned at the wheel.

### BRIEF DESCRIPTION OF THE DRAWINGS

FIG. 1 is a side view of an improved vehicle tire tie-down system and method;

FIG. 2 is a top view of the system shown in FIG. 1;

FIG. 3 is an end view of FIG. 2 showing of a deck of the system;

FIG. 4 is a side view of a wheel chock and winch assembly employed in FIG. 1;

FIG. 5 is a bottom view of a platform engagement member of the assembly of FIG. 4;

FIG. 6 is a top view of the wheel chock and winch assembly of FIG. 4;

FIG. 7 is a side view of a wheel chock and strap end securement assembly shown in FIG. 1;

FIG. 8 is a bottom view of a platform engagement member of the assembly of FIG. 7;

FIG. 9 is a top view of the assembly of FIG. 7;

FIG. 10 is an end view showing a torsion spring in a releasable platform engagement assembly used both in the wheel chock and winch assembly of FIG. 4 and in the wheel chock and strap end securement assembly of FIG. 7;

FIG. 11 is a cross-sectional view showing an end of a wheel securement strap engaged with and wrapped around a mandrel of a winch of the wheel chock and winch assembly of FIG. 1;

FIG. 12 is a plan view of the wheel securement strap of FIG. 1; and

FIG. 13 is a side view of the strap of FIG. 12.

### DESCRIPTION OF THE PREFERRED EMBODIMENT

For the purpose of promoting an understanding of the principles of the invention, reference will now be made to the preferred embodiment/best mode illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

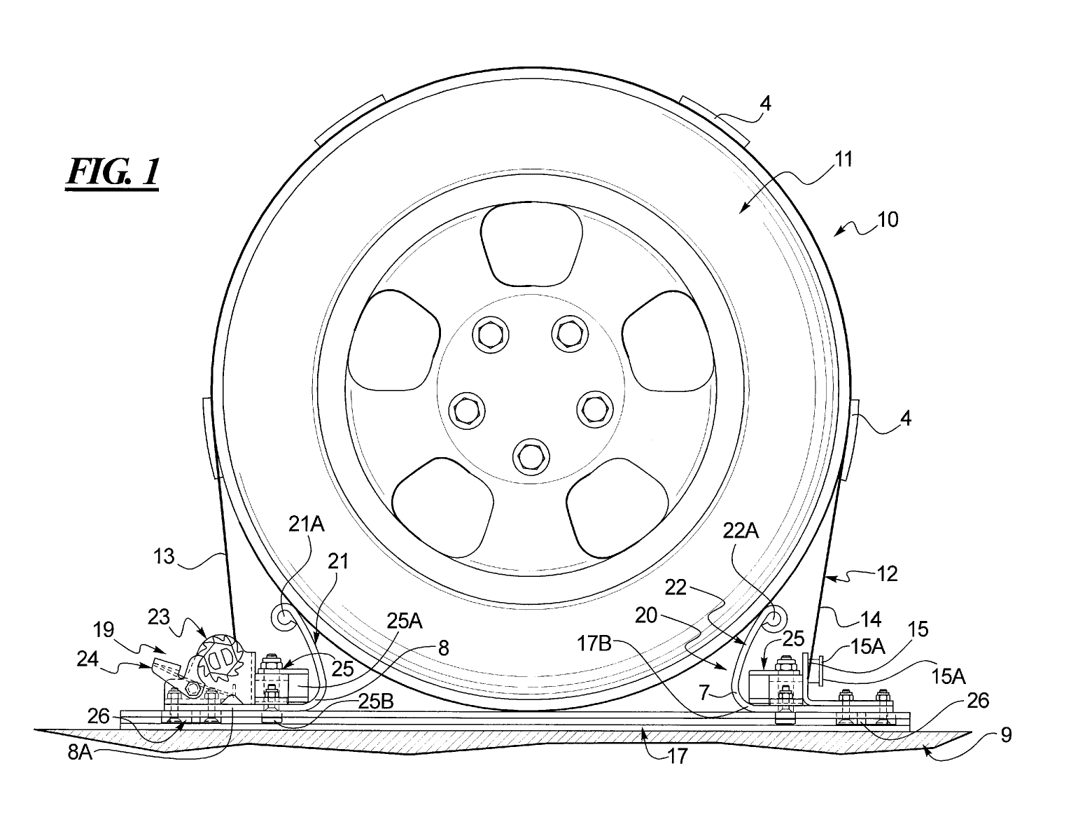

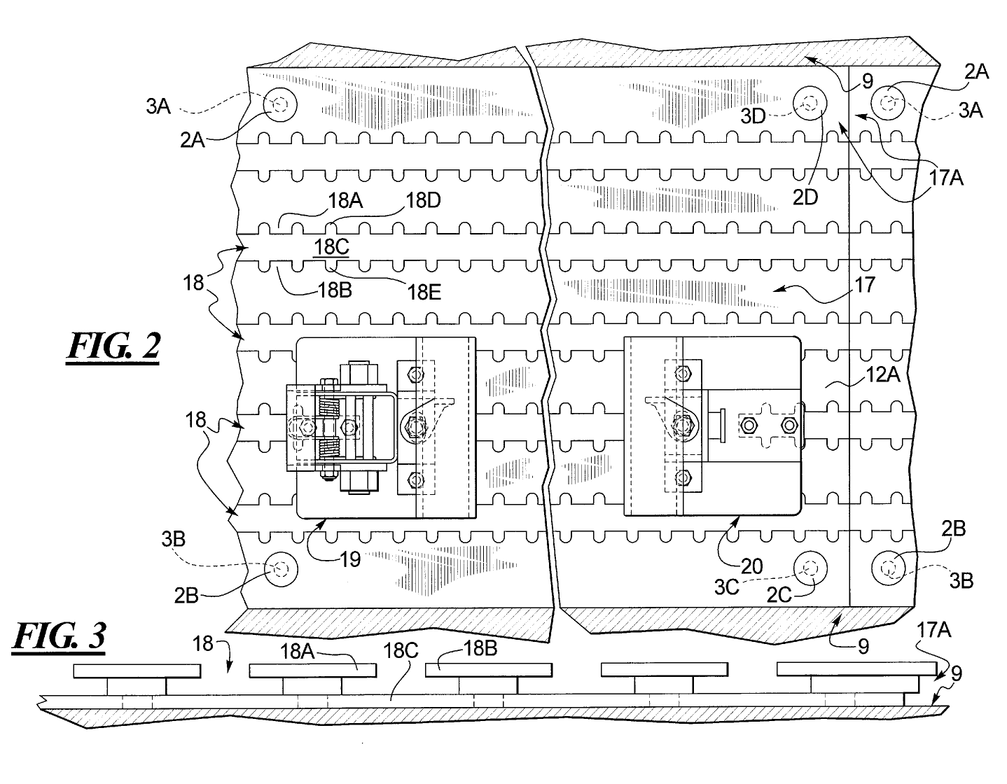

The improved vehicle tie tire-down system of a preferred/best mode embodiment is generally shown at 10 in FIG. 1. A tire or wheel 11 has a securement strap 12 partially wrapped therearound having cleats 4. On a platform 9, such as a railcar (although other types of platforms may be employed), a deck 17 is provided formed of a plurality of deck panels 17A each mounted to deck 9 with a plurality of mounting holes 3A, 3B, 3C, 3D with bolts 2A, 2B, 2C and 2D. On the deck 17, a wheel chock and winch assembly 19 is provided at one end 13 of the tire or wheel securement strap 12, and at the other end 14 of the strap 12 a wheel chock and strap end securement assembly 20 is provided. A springable chock arm 21 is provided on assembly 19 which preferably contacts one part of the wheel at a bent loop 21A. Similarly, springable chock arm 22 of assembly 20 contacts the tire at another location at bent loop 22A. The assembly 19 has a winch 23 and the assembly 20 has a strap end engagement member such as a stud or projection 15 with a lip 15A.

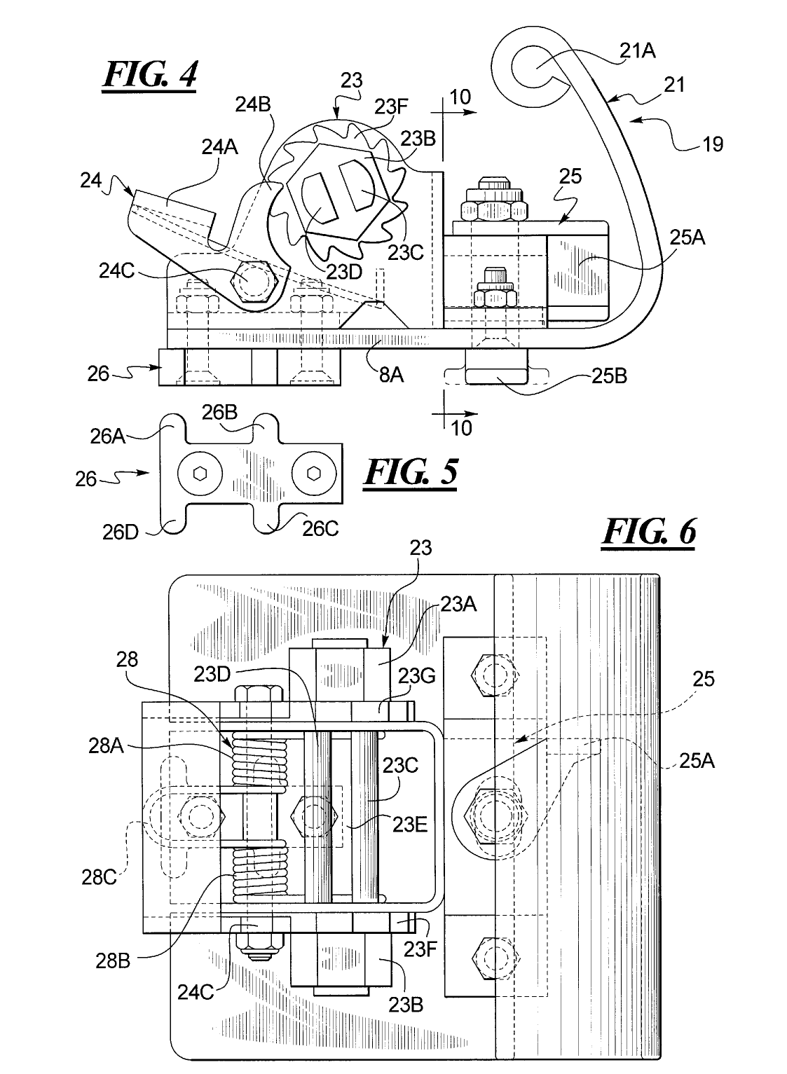

Each deck panel 17A has a plurality of longitudinal channels 18 defined by a floor 18C and overhanging flanges 18A and 18B above the floor 18C. The flanges each have a plurality of spaced notches 18D and 18E. The assemblies 19 and 20 both mount to the channel 18 in a similar fashion. Each assembly has a deck engagement member 26 (FIGS. 4, 5, 7, and 8) with lateral projections 26A, 26B, 26C, and 26D receivable in the notches 18D or 18E.

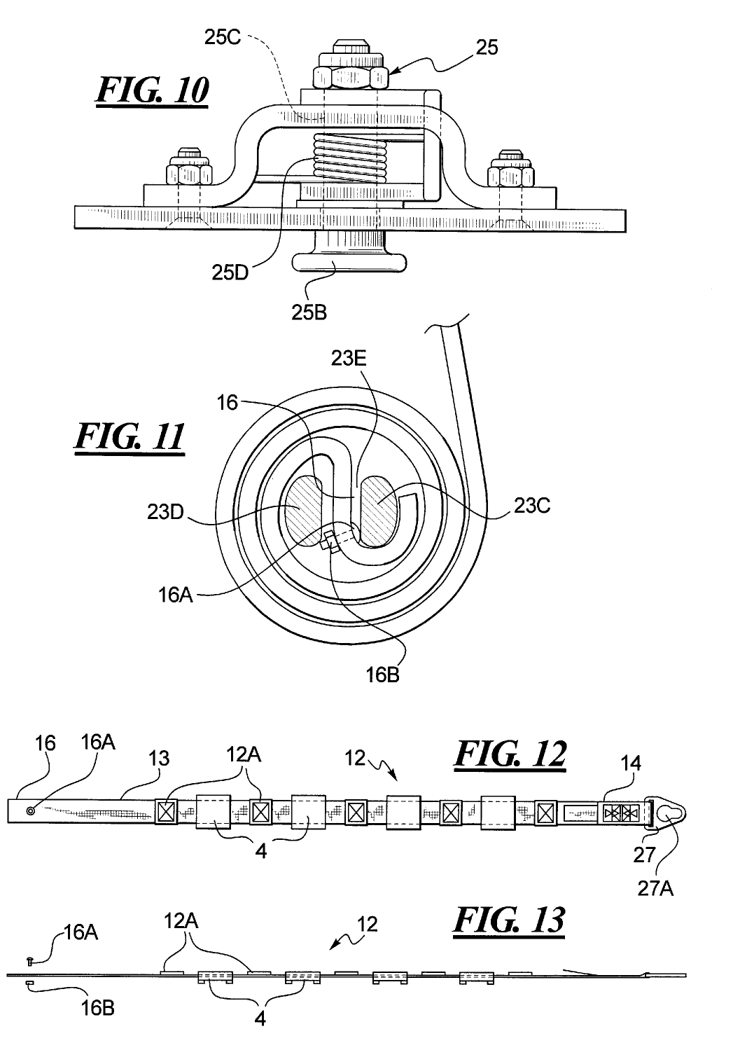

A releasable deck engagement assembly 25 is provided in each assembly 19 and 20. The assembly 25 has a push tab or handle 25A (FIGS. 4-10) causing rotation of a rotatable engagement member 25B. The rotatable engagement member 25B has a longitudinal extent greater than a distance between facing edges of the overhanging flanges 18A and 18B of the deck panel 17A. When the engagement member 25B is rotated against the force of a torsion spring so that its longitudinal extent is parallel to the longitudinal extent of the channel, the engagement member fits between the flanges. When the releasable engagement assembly 25 is released, it automatically flips back due to spring action of torsion spring 25D shown in FIG. 10 such that the longitudinal extent of the rotatable engagement member 25B is now perpendicular to the edges of the flanges, and ends of the rotatable engagement member 25B, which are preferably rounded, overlap the edges of the flanges. Thus the releasable deck engagement assembly 25 prevents vertical travel of the assembly 19 or 20 relative to the deck panel, and the deck engagement member 26 prevents lateral and longitudinal movement of the assembly 19 or 20.

It should be noted that because of the plurality of notches associated with the channels 18, the assemblies 19 and 20 have a longitudinal adjustment capability equal to a longitudinal spacing between the notches 18B or 18E in their respective flanges 18A and 18B.

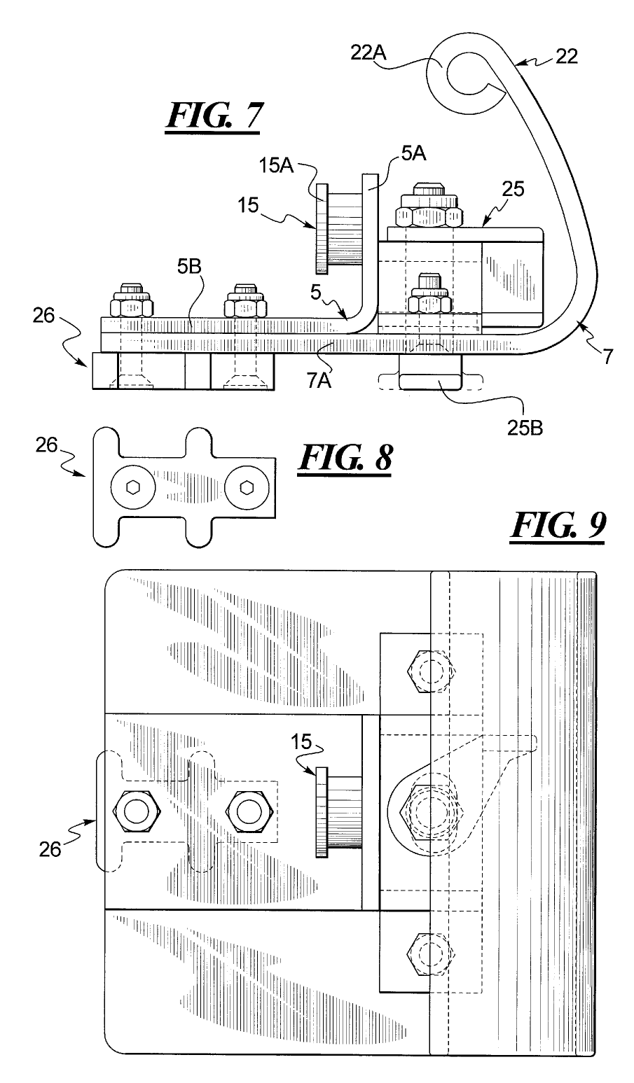

The springable chock arms 21 or 22 are formed from an overall strip 8 or 7 of the respective assemblies 19 and 20 wherein an end of the strip is bent up to form the springable chock arm 21 or 22, and a remaining portion of the respective strip serves as a base 8A or 7A. For assembly 19, the winch 23 is mounted on the base 8A along with the engagement member 26. Also the releasable deck engagement assembly 25 is mounted to the base 8A, as shown in FIG. 4. And for assembly 20 as shown in FIG. 7, the releasable deck engagement assembly 25 and the stud or projection 15 are mounted to the base 7A of strip 7. The stud 15 is mounted to an L-shaped strip 5 having a vertical portion 5A and a horizontal portion 5B as shown in FIG. 7. Stud 15 mounts at the vertical portion 5A.

As shown in FIGS. 4 and 6, the winch 23 has a mandrel comprising mandrel bars 23C and 23D forming a central slot 23E therebetween. Ends of the mandrel bars are attached to retaining nuts 23A and 23B by flattening the ends of the mandrel bars. Attached to each nut 23A or 23B is a respective ratchet wheel 23F or 23G engaged by a respective pawl 24B of pawl member 24. Pawl member 24 has a foot plate 24A engageable by an operator for disengaging the pawl from the teeth of the respective ratchet wheels. Ratchet member 24 rotates about the pivot axle 24C. Pawl member 24 is spring loaded by a torsion spring 28 having spring sections 28A and 28B with a central spring arm 28C most clearly shown in FIG. 6. Spring arm 28C is biased against the foot plate 24A.

As shown in FIG. 11, an end 13 of the strap 12 shown in FIG. 13 is inserted through the slot 23E of the mandrel. Preferably a retaining bolt or pin 16A may be attached by engaging a nut 16B with bolt 16A at the leading end 16 of strap 12 after the end 16 has been inserted through the slot (see FIGS. 11-13).

Details of the strap 12 are shown in FIG. 12. The strap 12 has at one end an attachment member 27 with an aperture such as a key hole slot 27A engageable with the stud or projection 15 and retained by the stud flange or end rim 15A. Strap 12 also has a plurality of cleats 4 which are hollow and which are slid onto the strap 12 and retained in place by sewing a folded over section of strap at locations 12A to the strap 12.

The functionality of the system and method of the best mode/preferred embodiment will now be described. The platform is formed of individual deck panels attached to the platform, such as on a railcar, with the mounting holes 3A, 3B, 3C, 3D and the appropriate bolts 2A, 2B, 2C, 2D through these holes. Alternatively, the longitudinal channels could be provided directly in the platform 9.

The wheel chock and winch assembly 19 is placed up against one portion of the wheel, and the wheel chock and strap end securement assembly 20 is placed against an opposite portion of the wheel. Since the springable chock arms 21 and 22 can deflect during transportation of the vehicle, there is play provided by the chock arms. They dampen movement of the vehicle and also provide additional tolerance and flexibility for longitudinal placement of the assemblies 19 and 20 relative to the wheel. The strap end attachment member 27 is then engaged with the projection or stud 15 such as by use of the key hole slot 27A. Strap 12 is then wrapped around the tire with the cleats 4 in position on the periphery of the wheel. The opposite end 13 with leading end 16 of the strap is then passed through the slot 23E of the mandrel and the securement bolt 16A with nut 16B is attached. One of the winding nuts 23A or 23B of winch 23 is then engaged, such as with a socket tool, to turn the mandrel to tighten the strap. To release the strap, the foot plate or pedal 24A is engaged by the operator to release the respective pawls 24B relative to the respective ratchet wheels 23F, 23G.

Many variations are contemplated. Although only one wheel chock and winch assembly has been shown, two of these assemblies 19 may be provided so that the second wheel chock and winch assembly 19 would replace the wheel chock and strap end securement assembly 20. In this case, the mandrel of either winch at either side of the wheel may then be rotated to tighten the strap.

Although in the preferred embodiment/best mode one type of engagement member 26 has been shown, other types of engagement members may be employed with different shapes and arrangements. Similarly, the notches in the overhanging flanges may be of different designs. Similarly the releasable deck engagement assembly 25 can have various designs, as may the rotatable engagement member 25B.

Furthermore, the springable chock arm 21 or 22 may have various designs, as may the base attached to the springable arm, such as by separate pieces, rather than contiguous and integral as shown.

The winch 23 may also have a variety of designs, and different types of release mechanisms may be employed in connection with the winch 23.

The securement strap may also have a variety of designs, including the use of various types of web assemblies with the strap.

The provision of the longitudinal channels for locking the assemblies 19 or 20 thereto may also have a variety of designs. Instead of separate deck panels, a single deck panel could be employed. The longitudinal channels could be part of the platform.

The design of the longitudinal channel may also have a variety of different designs for engagement with different types of engagement members and releasable engagement members.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

1. A vehicle wheel tie-down system for tying a wheel of a vehicle down at a load carrying platform, comprising:
an engagement receiving member associated with the platform;
a wheel chock and winch assembly having an engagement member received in said engagement receiving member;
a wheel strap end securement member;
a wheel strap for wrapping around the wheel and having one end connected to a winch of said winch and chock assembly and the other end connected to said wheel strap end securement member; and
the wheel chock and winch assembly having a springable chock arm.

2. A system of claim 1 wherein said wheel strap end securement member comprises a wheel chock and strap end securement assembly having a projection engageable by said one end of said strap and a springable chock arm.

3. A system of claim 1 wherein said wheel strap end securement member comprises another of said wheel chock and winch assemblies having a springable chock arm and a winch to which said one end of said strap is secured so that both ends of the strap are secured by the respective winches.

4. A system of claim 1 wherein said engagement receiving member on said platform comprises a longitudinal channel having flanges above a floor portion with a space between the edges of the flanges and notches in said flanges, and wherein said engagement member of said wheel chock and winch assembly comprises at least two oppositely facing projections received in respective ones of said notches in said oppositely facing flanges.

5. A system of claim 1 wherein said engagement member comprises two projections on one side receivable in two respective notches of one of the flanges and two projections on an opposite side receivable in two respective notches of the other flange.

6. A system of claim 1 wherein in addition to said engagement member said wheel chock and winch assembly also has a releasable engagement member which is rotatable such that in a first insertion position it can be placed between the flanges and in a second locking position it overlaps beneath the flanges.

7. A system of claim 6 wherein said rotatable releasable engagement member has an associated push tab, and is spring biased automatically to return to said locking position.

8. A system of claim 1 wherein said springable chock arm comprises a strip having one end bent up to form said springable chock arm and an opposite end of the strip as a base for receiving said winch.

9. A system of claim 1 wherein said engagement member is a separate piece connected by a screw to a base of said wheel chock and winch assembly.

10. A system of claim 1 wherein said springable chock arm has a bent portion providing a rounded surface at a top end of the springable chock arm.

11. A system of claim 1 wherein said wheel strap comprises a plurality of cleats.

12. A system of claim 1 wherein said wheel strap comprises a screw releasably mountable at one end for preventing movement of said end through a slot of a mandrel of said winch of said wheel chock and winch assembly.

13. A system of claim 1 wherein said winch of said winch and chock assembly comprises a mandrel having a slot receiving an end of said strap.

14. A system of claim 2 wherein an end of said strap has an aperture receivable over said projection.

15. A system of claim 1 wherein said platform has a deck thereon, said deck having said engagement receiving member.

16. A system of claim 15 wherein said engagement receiving member comprises a plurality of longitudinal channels in said deck, each longitudinal channel having a floor portion above which are provided respective flanges having oppositely facing edges defining a space therebetween, said flanges having notches therein.

17. A system of claim 15 wherein said deck comprises a plurality of deck panels, each deck panel having a plurality of longitudinal channels.

18. A system of claim 1 wherein said winch has a release pedal which releases the winch when the strap is to be loosened.

19. A vehicle wheel tie-down system for tying a wheel of a vehicle down at a load carrying platform having an associated engagement receiving member by use of a wheel strap, comprising:
a wheel chock and winch assembly comprising a winch for receiving an end of said strap and a springable chock arm for resting against a surface of said wheel when the wheel chock and winch assembly is positioned at said platform;
said wheel chock and winch assembly having an engagement member and a releasable and rotatable engagement member, both members being engageable with said engagement receiving member.

20. A system of claim 19 wherein the springable chock arm has a rounded surface at a top end.

21. A system of claim 19 wherein the springable chock arm comprises one end of a strip which is bent and whose opposite end serves as a base to which said winch, engagement member, and releasable and rotatable engagement member are mounted.

22. A system of claim 19 wherein said wheel chock and winch assembly releasable and rotatable engagement member has a longitudinal extent greater than a spacing between oppositely facing edges of a longitudinal channel of said engagement receiving member.

23. A vehicle wheel tie-down system for tying a wheel of a vehicle down at a load carrying platform, said platform having an engagement receiving member associated therewith, and the wheel being held by a strap, comprising:
a wheel chock and winch assembly comprising a winch, an engagement member having first, second, third, and fourth projections, said engagement member being a separate piece attached by a screw to a base, a rotatable engagement member having a longitudinal extent greater than its lateral extent, and the first and second projections are at one side of the separate piece and the third and fourth projections are at an opposite side of the separate piece.

24. A method for tying a wheel of a vehicle at a load carrying platform, comprising the steps of:
providing an engagement receiving member at said platform;
providing a wheel chock and winch assembly having a springable chock arm, a winch, an engagement member, and a rotatable engagement member;
providing a wheel chock and strap end securement assembly, said assembly having a springable chock arm, an engagement member, and a rotatable engagement member;
placing the wheel chock and winch assembly and the wheel chock and strap end securement assembly at the platform respectively adjacent opposite sides of the wheel so that the springable chock arms of each assembly are deflected by contact with the wheel, and engaging the respective engagement member and rotatable engagement member with the engagement receiving member on the platform;
engaging one end of a wheel retaining strap to a projection of said wheel chock and strap end securement assembly and connecting the opposite end of the strap to a mandrel of the winch of the wheel chock and winch assembly; and
tightening the winch to tighten the strap.

25. A method of claim 24 including the step of providing said engagement receiving member on said platform as a deck having a plurality of longitudinal channels, each channel having oppositely spaced flanges above a floor, providing a plurality of notches in each flange, and providing the engagement member with at least two projections.

26. A method of claim 25 including the step of providing said engagement member with first, second, third, and fourth projections all on an integral piece and engaging the four projections in respective notches in the flanges.

27. A method of claim 25 wherein said wheel chock and strap end securement assembly also has a winch, and wherein said first end of said strap is connected to said winch, and then at least one of the winches is rotated to tighten the strap.

28. A method of claim 25 wherein said wheel chock and strap end securement assembly comprises a projection and said one end of said strap has an aperture receiving said projection.

29. A method of claim 25 wherein said projection comprises a stud having a rim and said first end of said strap has a key hole receivable over said stud and retained by said rim.
